(19) United States
(12) Patent Application Publication
(10) Pub. No.: US 2025/0051184 A1
(43) Pub. Date: Feb. 13, 2025

(54) SYSTEM FOR REMOVING METALS FROM CONTAMINATED WASTE STREAMS AND METHODS OF USE THEREOF

(71) Applicant: Surfatas Corporation, LLC, Huntersville, NC (US)

(72) Inventor: Arvind S. Patil, Davidson, NC (US)

(21) Appl. No.: 18/366,746

(22) Filed: Aug. 8, 2023

(51) Int. Cl. C02F 1/00; C02F 1/42

(52) U.S. Cl. CPC C02F 1/001; C02F 1/42; C02F 2001/422; C02F 2001/425; C02F 2303/24

(57) ABSTRACT

Aspects of a chemical capture system for removing metals from a contaminated waste stream, are disclosed including a means for controlling the flow rate of the contaminated waste stream through the chemical capture system, a prefiltration stage, and a lead-lag system comprising a disposable chemical filtration cartridge in either the lead or the lag position.

### FIELD

This disclosure relates to chemical capture systems, particularly, systems for removing heavy metal contaminants (herein, “metal(s)”) from contaminated waste streams, and methods of use thereof.

### BACKGROUND

Waste streams contaminated with metal(s) are primarily generated from industrial emissions or from mine runoff. For example, in one United States (U.S.) manufacturing facility, where catalytic converters are produced, a day's operation usually results in about 30.0 thousand to about 40.0 thousand gallons of metal contaminated wastewater. As such, metal contamination in air, water, and other industrial emissions is a serious concern.

As used herein, the term “metal” or “metals” encompasses those elements having an atomic number of 23-33, 40-52, 57-84, and 89-92, and their atoms, ions, molecules, or compounds. Some of these metals have a density greater than about 5.0 grams per milliliter (g/mL). Specifically, the term “metal” or “metals” includes: Vanadium, Chromium, Manganese, Iron, Cobalt, Nickel, Copper, Zinc, Gallium, Germanium, Arsenic, Zirconium, Niobium, Molybdenum, Technetium, Ruthenium, Rhodium, Palladium, Silver, Cadmium, Indium, Tin, Antimony, Tellurium, Lanthanum, Cerium, Praseodymium, Neodymium, Promethium, Samarium, Europium, Gadolinium, Terbium, Dysprosium, Holmium, Erbium, Thulium, Ytterbium, Lutetium, Hafnium, Tantalum, Wolfram, Rhenium, Osmium, Iridium, Platinum, Gold, Mercury, Thallium, Lead, Bismuth, Polonium, Actinium, Thorium, Protactinium, and Uranium. Of these Chromium, Arsenic, Cadmium, Mercury, and Lead. The term “metal” or “metals” also includes all chemical equivalents as understood in the art.

In the U.S., the Environmental Protection Agency (“EPA”) regulates the presence of metal in municipal drinking water, for example. The EPA sets so-called maximum contaminant levels (“MCL”) for each metal based on the toxicity of each metal. When the concentration of a metal exceeds the EPA's MCL, U.S. EPA regulations demand lowering the concentration of the metal(s) through human intervention until the concentration is below the MCL. More specifically, a contaminated aqueous stream is typically defined as water with a metal concentration that is at least one part per million (ppm) greater than the MCL and, as such, qualifies as contaminated water unsuitable for consumption and in need of remediation.

Several conventional technologies are available for remediating metal contaminated wastewater streams. These technologies are applicable to drinking-water supplies, groundwater, industrial wastewater, surface water, and other miscellaneous applications (such as landfill leachate). Influent concentrations of metal(s) (i.e., metal(s) inputs) into these waste streams may vary by orders of magnitude over time, and the concentration of metal(s) inputs into these waste streams, as well as the other relevant water quality parameters (e.g., pH, large-particle contamination, rheological-complexity, temperature) may influence the performance and operating costs of each conventional treatment technology described herein.

One technology commonly used for removing metals from a contaminated wastewater stream is ion exchange or resin exchange technology; either for continuous-treatment processing or batch-treatment processing of the waste stream. Ion exchange resins are typically made of highly porous, polymeric material(s) that is/are acid, base, or water insoluble. The tiny beads that make up certain types of ion exchange resins may be made of hydrocarbons.

In general, there are two broad categories of ion exchange resins: cationic and anionic. The negatively charged cationic exchange resins (CER) are effective at removing positively-charged contaminants, and the positively charged anion exchange resins (AER) are effective at removing negatively-charged contaminants. Ion exchange resins, therefore, can be characterized as micro magnets that attract and hold the target contaminant from passing with the waste stream.

In practice, ion exchange is costly, slow, and cumbersome to implement, and the contaminated waste stream being treated must be passed through a significant amount of ion exchange resin (usually in the form of a filter bed; “resin medium” or “resin media”), which makes it effective in most cases only for treating relatively small volumes of effluent at one time. Consequently, the effluent also has to be re-cycled through the ion exchange resin medium. Even with retreatment, it is difficult to achieve close to 100% removal of any one type of contaminant using ion exchange resin systems.

As such, due to the complex synthetic chemistry demanded by the system, ion exchange resin technology usually results in an expensive and difficult to implement system for removing metals from a waste stream. The cost and complexity of building and maintaining an ion exchange resin system that can avoid certain metals and focus on certain, specific metal(s) is so great that this alone limits implementation of such systems. Moreover, ion exchange resin systems also are sensitive to, and highly effected by, suspended and/or colloidal material in the contaminated waste stream. Suspended or colloidal material results in shortened processing runs (in continuous or batch processing systems), plugged units, and fouled resins or filtration media, which ultimately causes the ion exchange resin system to either be shut down and/or by-passed. Lastly, once exhausted, ion exchange resins typically can only be regenerated for future use with caustic or alkaline liquid solutions. This process generates an alkaline-laced, metal contaminated waste stream that must be processed or dealt with at high risk and cost and that, frustratingly, still contains leftover metal contaminants.

Another set of technologies commonly used for removing metals from a contaminated waste stream are electro dialysis (ED) technologies and electrolysis technologies. In ED systems, ions are separated via electric potential differences. Generally, ED systems include a series of cation exchange membranes (CEMs) and anion exchange membranes (AEMs) (alternatively arranged in parallel), to separate ionic solutes. The anions pass through the AEMs, while the cations pass through the CEMs. A treated waste stream (the “diluate”) is produced by each ED system, and ED systems do not require phase changes, chemical reactions, or complicated chemical involvements or interactions to operate, and can operate over a wide range of pH values. However, ED systems suffer from membrane fouling, from the high cost of membranes, and from the high cost of generating significant electric fields.

Electrolysis technologies, in particular, electrochemical treatment systems, is another conventional technology for removing metals from contaminated waste streams. In an electrochemical treatment system, oxidation is performed at an anode (positively charged side) such that electrons transfer to a cathode (negatively charged side), completing a redox (reduction-oxidation) reaction, and leading to fluid purification through metal removal. Design choice for the anode and cathode generally influences the specific type of electrochemical method used, and dictates the metal removal efficiency. Generally, electrolysis is expensive, requires significant maintenance, employs other limited resources, creates secondary waste disposal problems, and are energy hungry. To make matter worse, electrolytic recovery is at best between about 70.0% to about 80.0% efficient at recovering or removing metals, and electrolyte systems are sensitive to the presence of other contaminants and foulants in the contaminated waste stream.

Electrochemical systems are typically classified as electrocoagulation (EC) systems, electrochemical reduction (ER) systems, electro flotation (EF) systems, or electro-oxidation (EO) systems. In ER systems, also known as electrodeposition and electroplating systems, targeted metal atoms, ions, molecules, or compounds are deposited onto the surface of a cathode. For example, cathodes made out of carbon or sulfur may be suitable for removing Mercury (Hg2+), Cadmium (Cd2+). Lead (Pb2+), and/or (Copper) Cu2+ from a contaminated waste stream. However, unlike ion exchange resin systems, ER systems do not produce sludge demanding further treatment.

In EC systems, non-toxic and reliable steel (iron) or aluminum electrodes are typically used. The process for each EC system may vary but can generally be described as follows: dissolving metal cations; forming hydroxo complexes or coagulants; allowing for aggregate stability and phase separation; and precipitation and flotation or flocculation. As such, EC systems commonly lead to the formation and precipitation of metal hydroxides, whose density is higher than water, and to the formation of floc which floats. EF and EO systems are similarly structured, share similar processes, and have similar deficiencies.

Another technology commonly used for removing metals from a contaminated waste stream is activated carbon adsorption. Activated carbon treatment or adsorption may also be used to adsorb natural organic compounds, taste and odor compounds, and synthetic organic chemicals in drinking water supplies, for example. Activated carbon is an effective solid adsorbent, as it is a highly porous material and provides a large surface area upon which contaminants may be adhered. Activated carbon usually is made from organic materials with high carbon contents such as wood, lignite, and coal, and often is used in a granular form called granular activated carbon (GAC), powdered activated carbon, or biochar. Conventional activated carbon filters, however, do not reduce metal concentrations in metal contaminated waste streams to acceptable levels.

It is, therefore, desirable to overcome the deficiencies of, and provide for improvements to, the state of the art. Thus, there is a need in the art for systems for, and methods of, removing metals from contaminated waste streams.

### SUMMARY

According to its major aspects and briefly recited, herein is disclosed a system for capturing precious metals, particularly, systems for removing heavy metal contaminants from a contaminated waste or recovery fluids from industrial process waste streams. These and other advantages will be apparent to those skilled in the art based on the following disclosure.

### BRIEF DESCRIPTION OF THE DRAWINGS

Many aspects of the present disclosure will be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views. It should be recognized that these implementations and embodiments are merely illustrative of the principles of the present disclosure. Therefore, in the drawings:

FIG. 1 is a plan view of an illustration of an example system and method for the precipitation of metal sludge from industrial wastewater and the recovery of metals from the metal sludge;

FIG. 2 is a plan view of an illustration of an example system and method for recovery of heavy metals from industrial wastewater;

FIG. 3 is a plan view of an illustration of a system and method for removing metals from a contaminated wastewater stream according to the present disclosure;

FIG. 4 is a perspective view of an illustration of an example mechanical filter for the prefiltration stage of a chemical capture system according to the present disclosure;

FIG. 5 is a perspective view of an illustration of an example disposable chemical filtration cartridge for a chemical capture system according to the present disclosure;

FIG. 6 shows a perspective view of an illustration of an example handle end of the disposable chemical filtration cartridge according to the present disclosure; and

FIG. 7 shows a perspective view of an illustration of another example disposable chemical filtration cartridge for a chemical capture system according to the present disclosure.

### DETAILED DESCRIPTION

The presently disclosed subject matter now will be described more fully hereinafter with reference to the accompanying drawings, if any, in which some, but not all embodiments of the presently disclosed subject matter are shown. Like numbers refer to like elements throughout. The presently disclosed subject matter may be embodied in many different forms and should not be construed as limited to the embodiments set forth herein; rather, these embodiments are provided so that this disclosure will satisfy applicable legal requirements. Indeed, many modifications and other embodiments of the presently disclosed subject matter set forth herein will come to mind to one skilled in the art to which the presently disclosed subject matter pertains having the benefit of the teachings presented in the foregoing descriptions and the associated drawings. Therefore, it is to be understood that the presently disclosed subject matter is not to be limited to the specific embodiments disclosed and that modifications and other embodiments are intended to be included within the scope of the appended claims.

Throughout this specification and the claims, the terms “comprise,” “comprises,” and “comprising” are used in a non-exclusive sense, except where the context requires otherwise. Likewise, the term “includes” and its grammatical variants are intended to be non-limiting, such that recitation of items in a list is not to the exclusion of other like items that can be substituted or added to the listed items.

### I. Example Use Case Scenarios

The present disclosure generally relates to systems and methods for managing liquid rivers and streams, exhaust gases or plumes, aqueous reservoirs and aquifers, and effluents and chemical runoff. These “waters” or “fluids” may be associated with industrial or consumer-good manufacturing processes, or the waters or fluids may be independent of any manufacturing process (i.e., the waters may be natural but contaminated waters, or may be contaminated municipal or agricultural waters, for example), all together referred to herein as “waste streams”. The present disclosure also generally relates to lakes, reservoirs, rivers, ponds, creeks, and springs.

Moreover, the present disclosure also generally relates to a system for and method of producing or reducing the inputs, especially harsh chemical inputs, necessary for waste stream processing. These inputs may be (1) energy, (2) fresh water or air, or (3) the active ingredients necessary for adequate processing, etc. Furthermore, the present invention also generally relates to reducing the non-useful, or potentially toxic, outputs from the waste stream processing systems and methods described herein. These outputs may be laden with unrecovered metals that are usually too difficult to capture or separate from a contaminated waste stream.

Embodiments and aspects of the present disclosure also provide an efficient, effective, and economical chemical capture system for removing metals from a contaminated waste stream. The inventive concepts described herein provide a solution that is not susceptible to the limitations and deficiencies of the prior art. The inventive concepts described herein also lessen the operating-costs, capital expenditures, and/or infrastructure that is needed to abide by environmental regulations in numerous jurisdictions and nations including the U.S. EPA.

Waste stream processing systems and methods commonly include or involve a large tank or a series of tanks storing the contaminated fluids. Then there is another tank or series of tanks where the waste stream from the earlier tank(s) is treated. In particular, the waste stream is treated to precipitate the metals, usually, by adjusting the pH of the waste stream. This precipitation tank(s), or step, usually is followed by another tank or series of tanks, where the waste stream with the precipitated metals undergoes, for example, flocculation enhanced by a polymer. The resulting supernatant liquid is then pumped into another tank, while the flocculated metal slurry is pumped into a filter press for dewatering. The cake from the filter press may result in recovery of about 60.0% to about 70.0% metal from the original contaminated waste stream. If the effluent resulting from either the flocculation step or the filter press step continues to contain any detectable or significant metal concentration, then these secondary effluents may be further processed through multiple ion exchange resin tanks, for example, in an attempt to recover the remaining metal.

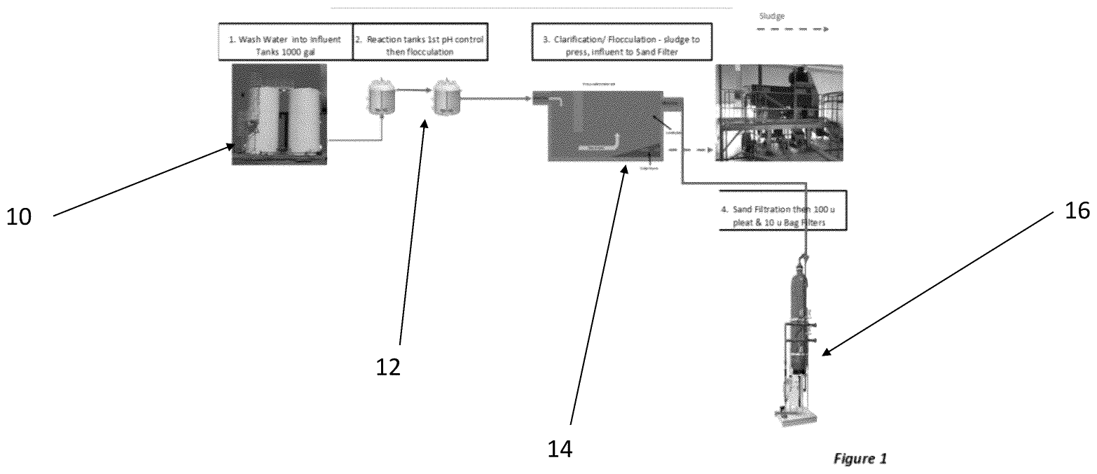

As further background and context, the art is rife with limitations and deficiencies. For example, FIG. 1 is a plan view of an illustration of an example system and method for the precipitation of metal sludge from industrial wash water and the recovery of metals from the metal sludge. As shown in FIG. 1, the wash water is stored in two approximate 5000-gallon tanks 10. From there, the wash water is transferred to a 1,000-gallon (approximate) reaction tank 12, where the pH of the solution is adjusted (raised) so as to precipitate the metals as hydroxide/oxides from the contaminated waste stream. This solution of floc-laden effluent is sent to a clarifier tank 14 where the flocculated metals are recovered (for example if not yet precipitated or recovered from the contaminated fluid), and where the remaining metal sludge residue is put through a filter press while the supernatant secondary effluent is drained and channeled to a sand filter 16. The remaining metal sludge residue, or cake, is subsequently incinerated to recover more metals. The supernatant secondary effluent, channeled to the sand filter, then passes through a 100 micron-sized (approximate) bag filter followed by a 10 micron-sized (approximate) pleated filter 16.

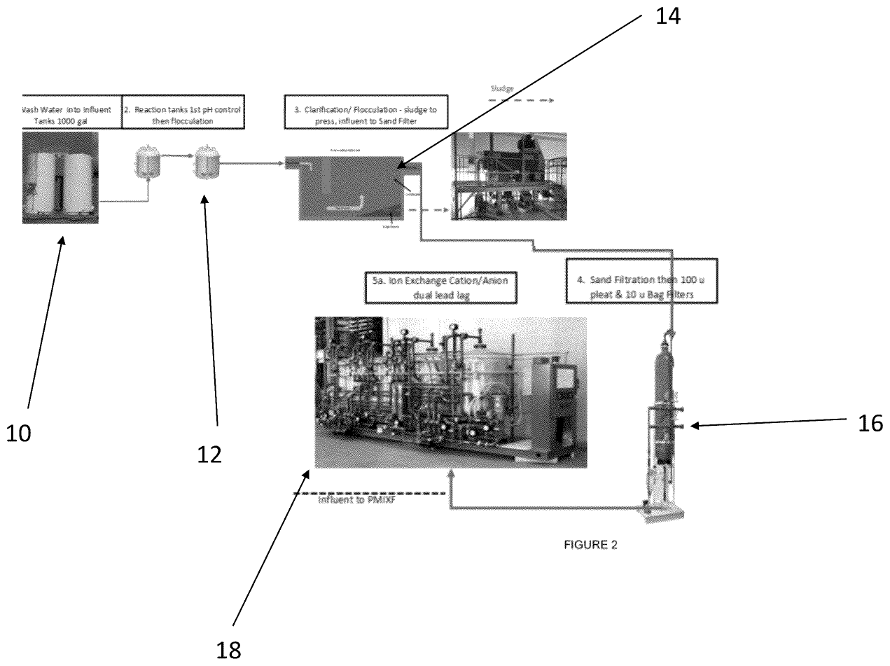

One solution for preventing metal waste in the tertiary effluent is illustrated in FIG. 2. In particular, FIG. 2 is a plan view of an illustration of an example system and method for removing metals from a contaminated waste stream. In particular, after passing through the sand filter, bag filter, and the pleated filter 16, the tertiary effluent may proceed to an ion exchange system 18 for ion exchange recovery. Cation and anion exchange resins are contained within tanks of the system 18. The resins can be both macroporous and/or gel strong acid cation and strong base anion resins functionalized on highly crosslinked DVB polystyrene backbone. They remove dissolved metals that are in the form of both cations and anions from the influent water. The current system in practice suffers from several disadvantages, including
1) Due to suspended matter in the wastewater from the sand filters, the ion exchange columns consisting of large tank farm are prone to frequent plugging & fouling necessitating frequent change out. Change out of large tank columns take large amount of time, resulting in costly down times
2) The wastewater from the sand filter also contains suspended organic matter which not only mechanically plug the resin but also allow growth of bacteria causing the fouling of the whole resin bed.
3) Strong acid cation resin is not selective enough to remove palladium selectively over other cations present at much larger concentration than palladium, so that percentage of palladium removed is not satisfactory resulting in the leakages, causing loss of costly palladium.

As such, in at least one aspect, the disclosure herein is directed to improved chemical capture systems, in particular, to a chemical capture system utilizing disposable cartridge-based filter systems for effectively removing metals from a contaminated waste stream without shutting down a stream for removal or replacement of filters. In the same vein, the lessons and techniques disclosed herein are applicable to any chemical capture system.

### II. Systems and Methods

In one aspect, the chemical capture systems and methods according to the present disclosure include or involve prefiltration of the contaminated waste stream before any reaction-chemistry or further mechanical filtration is performed on the contaminated waste stream. In another aspect, particles and particulates greater than about 1.0 micron in size to greater than about 0.1 microns in size are filtered from the contaminated waste stream to reduce the risk of plugging or fouling of ion exchange resins, membranes, filters, or substrates, for example. In another aspect, the prefiltration stage may include or involve radial-flow blow-molded depth filter(s) incorporating a disc filtration system. Moreover, in another aspect, the prefiltration stage and lead-lag filter system may include or involve parallel filters for uninterrupted prefiltration during plugged filter circumstances.

In one aspect, the chemical capture systems and methods according to the present disclosure include or involve a disposable mechanical filter(s) and chemical filtration cartridge(s) containing an ion exchange medium (media) with high affinity for specific, targeted metal(s). In another aspect, unlike conventional ion exchange media, the chemical capture systems and methods according to the present disclosure include or involve incineration of the exhausted ion exchange media instead of a regenerating step. The replaceable chemical filtration cartridge(s), in another aspect, can be easily, repeatedly, and frequently replaced, and the exhausted chemical filtration cartridge(s) can be wholly incinerated to efficiently recover the targeted metal(s). In another aspect, no tanks are necessary; instead, only cartridge holders may be needed. In another aspect, waste stream through the cartridge(s) can flow from the top down or from bottom up, or mixed and matched. Moreover, in another aspect, the cartridges may include a 226 connection(s) for secure attachment and detachment, and/or a means for converting radial flow to longitudinal flow. Furthermore, in an aspect, the cartridge may interconnect end to end (end to handle, for example).

In one aspect, the chemical capture systems and methods according to the present disclosure include or involve a means for controlling the flow rate of the waste stream (at all stages of processing) through the system.

In one aspect, the chemical capture systems and methods according to the present disclosure include or involve about 98.0% to about 99.0% recovery of metal(s) from a contaminated waste stream, with near zero down-time needed for a continuous-process operation.

In one aspect, all of some of components of the chemical capture systems according the present disclosure, such as the prefiltration stage, may be configured as disposable cartridges capable of ready removal and replacement.

### III. With Reference to the Figures

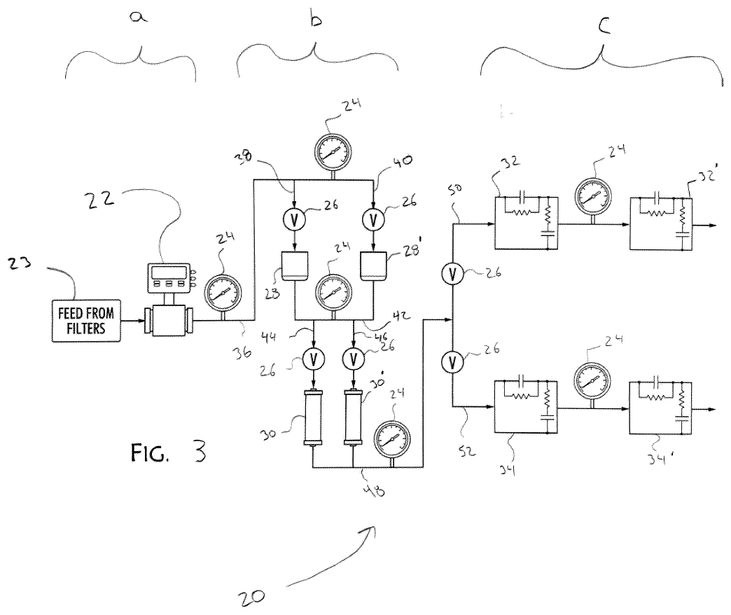

Referring now to FIG. 3, a schematic view of an illustration of an example system and method for removing metals from a contaminated waste stream is shown. The chemical capture system includes but is not limited to (a) a means for controlling the flow rate of the waste stream (at all stages of processing); (b) a prefiltration stage, and (c) a lead-lag filter system. In particular, in FIG. 3, the prefiltration stage is followed by the lead-lag filter system, containing disposable filter cartridges in a lead-lag configuration (which could be a dual lead-lag overall arrangement, and so on so forth) with each cartridge containing cation exchange media or anion exchange media.

More specifically, as illustrated in FIG. 3, the prefiltration stage includes a pair of mechanical filters 28, arranged in parallel, made of blow-molded nonwoven polypropylene and configured for ready removal and replacement. The prefiltration stage also is configured to remove particles and particulates greater than about 0.1 microns in size to reduce the risk of plugging or fouling the downstream lead-lag filter system, for example. In particular, the prefiltration stage includes two mechanical filters, arranged in parallel, for removing all sedimentary particles above about 1.0 micron in size followed by two membrane filters 30, arranged in parallel, to remove matter from about 0.5 microns in size to about 0.1 microns in size. Moreover, the prefiltration stage may be housed in a sturdy housing for uninterrupted prefiltration and redundancy.

Returning generally to FIG. 3, the lead-lag filter system contains chemical filtration cartridges 32, 32′, 34, 34′ that are disposable, that contain cation exchange media, specifically, weak acid cation chelating resin with iminodiacetic-acid functional side groups. In particular, each chemical filtration cartridge 32, 32′, 34, 34′ has an internal screen, with openings sized from about 1.0 micron to about 1,300.0 microns, holding the cation exchange media. Each chemical filtration cartridge 32, 32′, 34, 34′ also has a dual distribution structure allowing the contaminated waste stream flowing within the chemical filtration cartridge 32, 32′, 34, 34′ to have at least two contact paths with the cation exchange media.

As illustrated in FIG. 3, the lead-lag filter system contains two flow paths for wastewater to flow after exiting the prefiltration stage. The first flow path contains two chemical filtration cartridge 32, 32′ arranged in series along a flow path, attached end to end, for example, allows for wastewater to flow through the chemical filtration cartridges 32, 32′ and the cation exchange media for maximum contact time with the cation exchange media and at the ideal flow rate for the chemical reaction. The internal structure of each chemical filtration cartridge 32. 32′ allows for the wastewater stream to flow longitudinally through the chemical filtration cartridges 32, 32′ in series, from top to bottom, or from bottom to top, instead of radially from outside in or inside out. Similarly, the second flow path contains two chemical filtration cartridges 34, 34′ arranged in series along a separate flow path, attached end to end, for example, allows for wastewater to flow through the chemical filtration cartridges 34, 34′ and the cation exchange media for maximum contact time with the cation exchange media and at the ideal flow rate for the chemical reaction. The internal structure of each chemical filtration cartridge 34, 34′ allows for the wastewater stream to flow longitudinally through the chemical filtration cartridges 34, 34′ in series, from top to bottom, or from bottom to top, instead of radially from outside in or inside out.

More specifically, as illustrated in FIG. 3, the cation exchange media of the chemical filtration cartridges 32, 32′, 34, 34′ of the lead-lag filter system within the chemical capture system 20 contains a mixture of beads and fibers with exposed iminodiacetic-acid functional side groups. The physical structure of the beads and fibers, as well as their iminodiacetic-acid functionality, gives the cation exchange media a chelating ability with high affinity for Palladium, Platinum, and/or Rhodium over other cations. The fibers, in particular, fine extruded functionalized ion exchange fibers made from either polystyrene or polyacrylic polymers, are about 0.1% to about 10.0% of the total cation exchange media weight. The cation exchange media also prevent pH swings which allows the chemical capture system to have a high affinity for Palladium, Platinum, and/or Rhodium.

Therefore, each of the chemical filtration cartridges 32, 32′, 34, 34′ is configured, once the cation exchange media is exhausted, to be wholly incinerated instead of chemically regenerated. Each chemical filtration cartridge 32, 32′, 34, 34′ can be disconnected from the series connection and readily and easily removed and replaced, and taken to an incineration stage (not shown) for processing to efficiently recover the targeted metal(s). In this way, the overall chemical capture system 20 including the prefiltration stage and the lead-lag filter system allows for about 98.0% to about 99.0% recovery of Palladium, Platinum, and/or Rhodium from the effluent or wastewater (as a continuous-process operation).

Returning generally to FIG. 3, the means for controlling the flow rate of the waste stream is a flow meter and control system 22 containing a pump with a badger flow meter to control the flow. The flow meter and control system 22 adjusts and maintains the flow rate and pressure of the wastewater feed 23 entering the system 20, such as a system illustrated in FIG. 3, so that ideal contact time between the contaminated wastewater and the cation exchange media is achieved. The wastewater feed 23 enters the flow meter and control system 22 through an inlet and exits through an exit, wherein the flow is controlled by the pump with a badger flow meter. The wastewater proceeds through a pipe or flow path 36, wherein the pressure within the pipe 36 is measured by a pressure gauge 24. The wastewater may then either proceed through two alternate flow paths, indicated by pipe 38 and pipe 40, wherein the flow of wastewater through pipe 38 and pipe 40 is governed by a valve 26. If the valve 26 connected with pipe 38 is in the “closed” position preventing the flow of wastewater through the pipe 38, the wastewater is diverted through pipe 40, when the valve 26 connected with pipe 40 is in the “open” position allowing wastewater to flow through pipe 40. If the valve 26 connected with pipe 40 is in the “closed” position preventing the flow of wastewater through pipe 40, the wastewater is diverted through pipe 38, when the valve 26 connected with pipe 38 is in the “open” position. The wastewater flowing through pipe 38 flows through mechanical filter 28 for filtering the wastewater, and the wastewater flowing through pipe 40 flows through mechanical filter 28′ for filtering the wastewater. The wastewater exits the filters 28, 28′ and flows into pipe 42 that includes a pressure gauge 24 for monitoring the pressure within pipe 42. When a mechanical filter 28, 28′ needs to be replaced, the valve 26 can be changed to the “off” position, preventing wastewater from proceeding through the respective pipe 38, 40 feeding wastewater to the mechanical filter 28, 28′ that needs to be replaced, allowing the mechanical filter 28, 28′ to be removed and replaced, while the wastewater flows through the opposed pipe 38, 40 and opposed mechanical filter 28, 28′, allowing wastewater to flow continuously through the system 20 so there is no down time when a mechanical filter 28,28′ needs to be replaced.

After the wastewater proceeds through the mechanical filters 28, 28′, this filtered wastewater proceeds through pipe 42, wherein the wastewater can proceed through two different flow paths, indicated by pipe 44 and 46. The flow of wastewater through pipe 44 is governed by valve 26 connected to pipe 44, and the flow of wastewater through pipe 46 is governed by valve 26 connected to pipe 46. When valve 26 within pipe 44 is in the “closed” position, wastewater cannot flow through pipe 44, and the wastewater is directed through pipe 46 and proceeds through pipe 46. When the valve 26 within pipe 46 is in the “closed” position, wastewater cannot flow through the pipe 46, and the wastewater is directed through pipe 44 and proceeds through pipe 44. The wastewater proceeding through pipe 44 flows through membrane filter 30 for filtering. The wastewater proceeding through pipe 46 flows through membrane filter 30′ for filtering. When a membrane filter 30, 30′ needs to be replaced, the valve 26 can be changed to the “off” position, preventing wastewater from proceeding through the respective pipe 44, 46, engaged to the membrane filter 30, 30′, allowing the membrane filter 28, 28′ to be removed and replaced, while the wastewater flows through the opposed pipe 44, 46 and opposed membrane filter 30,30′, allowing wastewater to continuously flow through the system 20 so there is no down time when a membrane filter 30, 30′ needs replacing.

The wastewater then flows through pipe 48, where the pressure within the pipe 48 is monitored by a pressure gauge 24, exiting the prefiltration stage. The wastewater then proceeds to the lead-lag filter system, where the wastewater may proceed through two different flow paths. indicated by pipe 50 and pipe 52. A valve 26 is connected with pipe 50, and a valve 26 is connected with pipe 52. The flow of wastewater through pipe 50 is governed by valve 26, and the flow of wastewater through pipe 52 is governed by valve 26. When valve 26 within pipe 50 is in the “closed” position, wastewater cannot flow through pipe 50, and the wastewater is directed through pipe 52 and proceeds through pipe 52. When the valve 26 within pipe 52 is in the “closed” position, wastewater cannot flow through the pipe 52, and the wastewater is directed through pipe 50 and proceeds through pipe 50. The wastewater proceeding through pipe 50 flows through the first chemical filtration cartridge 32 for filtering and then flows through the second chemical filtration cartridge 32′ for filtering. The pressure of the wastewater between the first chemical filtration cartridge 32 and the second chemical filtration cartridge 32′ is monitored by a pressure gauge 24. The wastewater proceeding through pipe 52 flows through the first chemical filtration cartridge 34 for filtering and then flows through the second chemical filtration cartridge 34′ for filtering. The pressure of the wastewater between the first chemical filtration cartridge 34 and the second chemical filtration cartridge 34′ is monitored by a pressure gauge 24. When the first chemical filtration cartridge 32 and/or the second chemical filtration cartridge 32′ needs to be replaced, the valve 26 can be turned to the “off” position, preventing wastewater from proceeding through the pipe 50, and diverting the wastewater through pipe 52 and the first chemical filtration cartridge 34 and the second chemical filtration cartridge 34′. When the first chemical filtration cartridge 34 and the second chemical filtration cartridge 34′ need to be replaced, the valve 26 can be turned to the “off” position, preventing wastewater from proceeding through the pipe 52, and diverting the wastewater through pipe 50 and the first chemical filtration cartridge 32 and the second chemical filtration cartridge 32′.

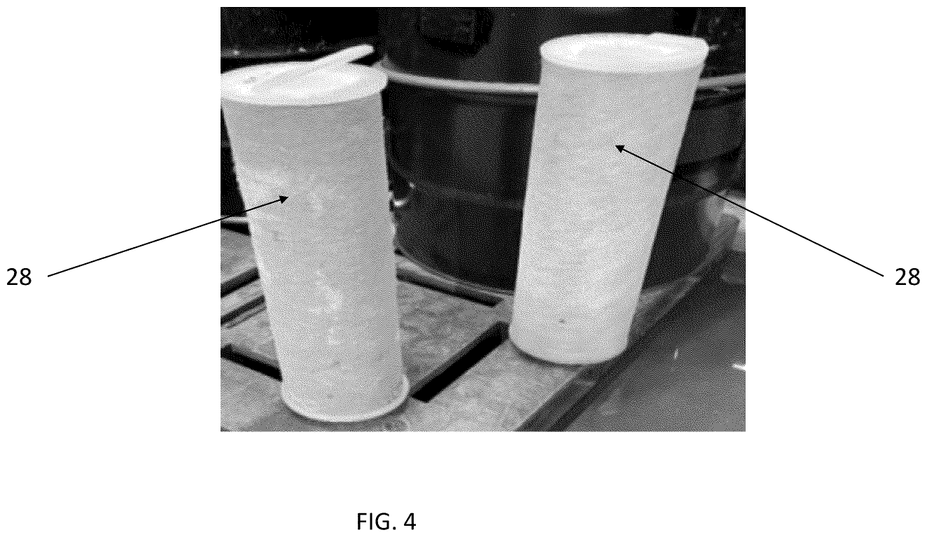

Referring now to FIG. 4, a perspective view of an illustration of an example mechanical filter 28 that is a radial flow blow molded nonwoven polypropylene disposable filter for the prefiltration stage of the chemical capture system 20 according to the present disclosure is shown. The mechanical filter 28 is capable of ready removal and replacement from a prefiltration steel housing (not shown), and is about 6.0 inches in outer diameter and about 30.0 inches tall (although any size or dimensions is envisioned). The radial flow blow molded nonwoven polypropylene disposable filter removes the sedimentary particles above about 1.0 micron in size.

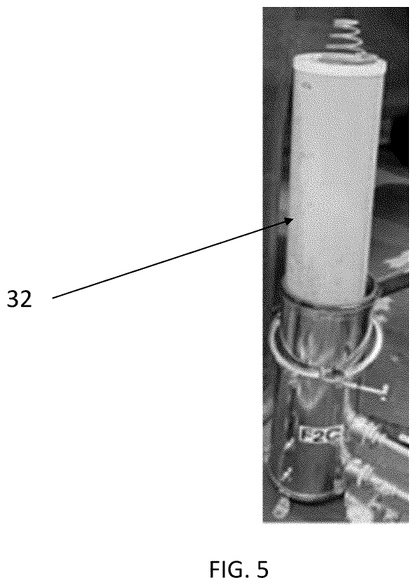

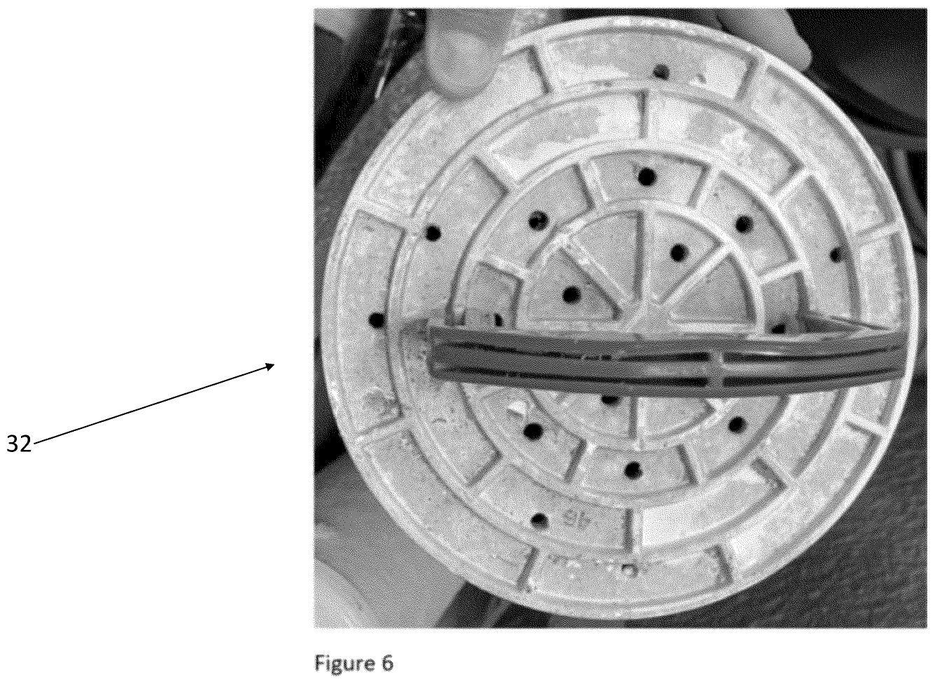

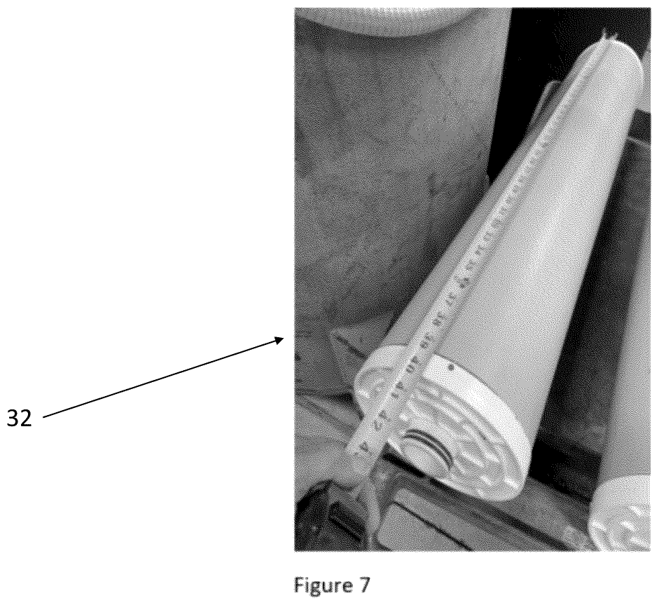

Referring now to FIGS. 5-7, FIG. 5 shows a perspective view of an illustration of an example chemical filtration cartridge 32 for a chemical capture system 20 according to the present disclosure; FIG. 6 shows a perspective view of an illustration of an example handle end of the chemical filtration cartridge 32 according to the present disclosure; and FIG. 7 shows a perspective view of an illustration of another example a chemical filtration cartridge 32 for a chemical capture system 20 according to the present disclosure. The chemical filtration cartridges 32 is capable of ready removal and replacement from a housing structure, and contains about 40.0 lbs. of weak acid cation chelating resin with iminodiacetic-acid functional side groups. Moreover, the disposable chemical filtration cartridge is about 8.0 inches in outer diameter and about 3.3 feet tall. In particular, the chemical filtration cartridge 32 includes but is not limited to a side wall bounding the internal cartridge structure and screen which holds the cation exchange media, and a first end having a handle and a second end having a 226 connection. As such, two or more chemical filtration cartridges 32 are connected in series, attached end to end, for example, via the 226 connection(s), allows for wastewater to flow through the cartridge structure for maximum contact time with the cation exchange media and at the ideal flow rate for the chemical reaction. The internal structure allows for the waste stream to flow longitudinally through the cartridge from top to bottom, or from bottom to top, instead of radially from outside in or inside out.

In one of the major manufacturing facilities for catalytic converters, washout solution for a day's production results in approximately 30 to 40 thousand gallons of water containing concentrations of precious metals in the wastewater. A major portion of these precious metals are recovered in the Wastewater Treatment Plant by precipitation as shown in FIG. 1. There is a daily report of the concentration of precious metals in this filtered wastewater. A representative analysis showed that this wastewater contained 2400 ppb (parts per billion) of Palladium (Pd), 15 ppm of Platinum (Pt), and 16 ppb of Rhodium (Rh), indicating that palladium was the most important constituent here that was worth recovering. With the total annual water volume for such a plant of 4,500 million gallon, any loses even of small quantities, add up to huge annual loss since precious metals are so expensive.

An improved system, as set forth herein, to realize much larger recovery from the waste stream from sand filter involves:
1) Incorporating a prefiltration stage that takes out all suspended particles to 1-micron size or even <0.1 micron by Radial flow blow molded depth filter utilizing a disc filtering system. Design of easy to replace parallel filter arrangement enables easy replacement of plugged pre-filter.
2) Substituting easy to install and substitute ion exchange cartridge system instead of using large bulky tank farms, that are fixed in place and where it is difficult and time consuming to replace the spent resin. Change out times of this new cartridge system is very quick.
3) Cartridge design is key to provide necessary velocity through unit allowing for the correct empty bed contact time for ion exchange to occur. Flow through cartridges can be top down or bottom up and to include a mounting mechanism to ensure the cartridge stays secure with 226 connections as well as converting radial flow to longitudinal flow.
4) Cartridge material is bonded and compatible with each other to connect sidewall with handle and 226 connections.
5) Internal screen design in the cartridge to contain the media have dual distribution as well as screen opening sizes from 1-1300 micron.
6) Utilizing much more selective ion exchange system, which removes palladium by over 98%. The resin is functionalized by Iminodiacetic acid, which gives it chelating ability to selectively remove palladium and other precious metals over other cations. Addition of 0.1-10% fine extruded functionalized ion exchange fiber made from either polystyrene or polyacrylic polymer enhances removal.
7) Adjusting and maintaining rate and velocity of wastewater influent to the ion exchange cartridge, so that optimum contact time with the resin is achieved by using a Badger flow meter.
8) The process uses the system of lead and lag and incorporates a dual lead and lag filter system in the final installation.
9) The exhausted resin, which is incinerated to recover the adsorbed palladium and other precious metals, is very easy to remove from cartridge system than removing the resin from a fixed bed bulky tank.
10) With these improvements, it is now possible to reduce the downtimes to zero and achieve a 99+% continuous operation.
11) This has also allowed for more consistent turbidity control and concentration of palladium and other precious metals in the influent to the ion exchange cartridge system.
12) The new process and the process stream has reduced the maintenance and labor costs to minimum.
   Performance after Reduction to Practice:

Table 1 below indicates the differences in the performance of the chemical capture system 20 of the present invention as described herein and current recovery process:

TABLE 1

| Description | Present Process | Improved Process |
|---|---|---|
| Pd removal from 61,000 gallons of | 81.6% * | 98.2% |
| Wastewater containing 2.4 ppm Pd | | |
| Runnability | 51% | 99% |
| Pd Recovery from the incineration | 0.179 | 0.561 |
| Of resin in Troy Ounces/lb. resin | | |

* This number (81.6%) looks higher because it is contacting 1500 lb. of resin, whereas the filter cartridge in the Improved Process contains only 39 lb. resin to treat the same amount of influent.

As indicated in Table 1, the chemical capture system 20 results in the recovery of significantly more palladium, substantially increased runnability without down-time.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

1. A chemical capture system for removing metals from a contaminated waste stream, comprising:
(i) a prefiltration stage;
(ii) a lead-lag system comprising a filtration device in either the lead or the lag position; and
(iii) a means for controlling the flow rate of the contaminated waste stream through the chemical capture system.

2. The chemical capture system of claim 1, wherein the prefiltration stage is positioned upstream of the lead-lag system.

3. The chemical capture system of claim 1, wherein the prefiltration stage filters particles and particulates greater than 1.0 micron in size to greater than about 0.1 microns in size.

4. The chemical capture system of claim 1, wherein the prefiltration stage filters particles and particulates greater than about 0.1 microns in size.

5. The chemical capture system of claim 1, wherein the prefiltration stage comprises a radial-flow blow-molded depth filter or a disc filtration system or both.

6. The chemical capture system of claim 5, wherein the radial-flow blow-molded depth filter is made of blow-molded nonwoven polypropylene.

7. The chemical capture system of claim 1, wherein the lead-lag system is at least a dual lead-lag system.

8. The chemical capture system of claim 1, wherein the filtration device of the lead-lag system comprises an anion exchange media.

9. The chemical capture system of claim 1, wherein the filtration device of the lead-lag system comprises a cation exchange media.

10. The chemical capture system of claim 9, wherein the cation exchange media is a weak acid cation chelating resin with iminodiacetic-acid functional side groups.

11. The chemical capture system of claim 9, wherein the filtration device has an internal structure configured to channel the contaminated waste stream such that the contaminated waste stream flows longitudinally, through the cation exchange media, and not radially from outside in or inside out.

12. The chemical capture system of claim 11, wherein the cation exchange media is configured as beads and fibers and made with a chemical structure having exposed iminodiacetic-acid functional side groups.

13. The chemical capture system of claim 1, wherein the filtration device is configured to be wholly incinerated.

14. The chemical capture system of claim 9, wherein the means for controlling the flow rate of the contaminated waste stream is a badger flow meter and control system.

15. A chemical capture system for removing metals from a contaminated waste stream, comprising:
(i) a prefiltration stage;
(ii) a dual lead-lag system comprising filtration devices, wherein at least one of the filtration devices comprises cation exchange media; and
(iii) a badger flow meter and control system for controlling the flow rate of the contaminated waste stream through the chemical capture system;
wherein the prefiltration stage is positioned upstream of the lead-lag system; and
wherein the filtration device comprising the cation exchange media is configured to be wholly incinerated for recovery of at least some of the metals removed from the contaminated waste stream.

16. The chemical capture system of claim 15, wherein the prefiltration stage comprises a mechanical turbo disc filtration sub-system for removing particle or particulate matter from 1.0 micron in size to 0.5 microns in size followed by an ultrafiltration hollow tube membrane filter to remove particle or particulate matter from about 0.5 microns in size to about 0.1 microns in size, and wherein the blow-molded nonwoven polypropylene removes all sedimentary particles above 1.0 micron in size.

17. The chemical capture system of claim 15, wherein the cation exchange media is a weak acid cation chelating resin with iminodiacetic-acid functional side groups.

18. The chemical capture system of claim 15, wherein the filtration devices have an internal structure configured to channel the contaminated waste stream such that the contaminated waste stream flows longitudinally, through the cation exchange media, and not radially from outside in or inside out.

19. The chemical capture system of claim 11, wherein the cation exchange media is configured as beads and fibers and made with a chemical structure having exposed iminodiacetic-acid functional side groups.

20. A method of chemical capture for removing metals from a contaminated waste stream, the method comprising:
(i) prefiltering the contaminated waste stream to produce a first contaminated effluent;
(ii) filtering the first contaminated effluent via a dual lead-lag system comprising a plurality of filtration devices, wherein at least one of the plurality of filtration devices comprises cation exchange media; and
(iii) controlling the flow rate of the contaminated waste stream or the contaminated effluent through the chemical capture system via a badger flow meter and control system;
(iv) removing the at least one of filtration devices; and
(v) wholly incinerating the at least one of filtration devices for recovery of at least some of the metals removed from the contaminated waste stream.
